(19) United States
(12) Patent Application Publication
(10) Pub. No.: US 2002/0049605 A1
(43) Pub. Date: Apr. 25, 2002

(54) Electronic business transaction system including server device, client device and connecting terminal used therein

(75) Inventor: Kazuo Hagi, Tokyo (JP)

Correspondence Address: McGuire Woods LLP, 1750 Tysons Boulevard, Suite 1800, McLean, VA, 22102, US

(73) Assignee: NEC

(21) Appl. No.: 09/855,847

(22) Filed: May 16, 2001

(30) Foreign Application Priority Data
May 17, 2000 (JP) 2000-145316

(51) Int. Cl. G06F 7/00

(52) U.S. Cl. 705/1

(57) ABSTRACT

The server device comprises a database for storing identification information for identifying the client in correspondence with an individual password assigned to the client, obtaining means for obtaining the telephone number information of the client transmitted via the communications line, and retrieving means for retrieving the identification information from the database based on the telephone number information obtained by the obtaining means. And when the telephone number information is authenticated as the information of the client according to the identification information retrieved by retrieving means, an image for returning the password is transmitted with respect to the client. And in the event the password returned from the client matches the password stored in the database, the services are provided from the server device to the client.

### BACKGROUND OF THE INVENTION:

The present invention relates to an electronic business transaction system including a server device, a client device and connecting terminal used therein.

Conventionally, as the use of personal computers (PC), mobile terminals and the like became widespread and the number of the Internet users increased, the electronic business transaction performed by exchanging information between the client device such as PCs, mobile terminals and the like and the server device owned by banks security companies, insurance companies, department stores and the like via the Internet has been popularized.

FIG. 9 is a block diagram of a conventional electronic business transaction system. A server device 70 for providing services, a client device 50 for receiving the services provided by the server device 70, the Internet 400 for connecting the server with the client devices, an Internet connecting terminal 60 and a telephone network 300 are illustrated in FIG. 9.

FIG. 10 is a sequence diagram for illustrating an operation of the business transaction system shown in FIG. 9. An operation of the electronic business transaction system shown in FIG. 9 is described taking an example of FIG. 10 in which a service user receives services provided by, for example, a bank by accessing the server device 70 owned by the bank.

First, a service user as a client outputs a request for connecting the client device 50 with the server device 70 to the Internet connecting terminal 60 via the telephone network 300 by operating the client device 50 (FIG. 10 (a)). Then the client device 50 is connected to the Internet connecting terminal 60 via the telephone network 300.

Thereafter, an address of the server device 70 transmitted from the service user by operating the client device 50 is received by the Internet connecting terminal 60 via the telephone network 300. Then the Internet connecting terminal 60 and the client device 50 are connected to the Internet 400 and the server 70 respectively in response to the request output from the Internet connecting terminal 60 with respect to the Internet 400 for connecting the server device 70 thereto (FIG. 10 (b)).

Next, the server device 70 transmits an image available for inputting a user ID and a password as an example shown in FIG. 11 with respect to the client device 50 (FIG. 10 (c)). The service user inputs the user ID and the password based on the image shown in FIG. 11 and transmits to the server device 70 (FIG. 10 (d)).

Incidentally, the above-mentioned user ID refers to the individual identification number assigned to each of the users for their identifications and [qlw234] is named as an example ID here. And the above-mentioned password refers to a number such as a personal identification code of a deposit account, for example, for ensuring security on the Internet 400 and the like. The user ID and the password are stored in a database not shown on the side of the bank in the lump.

Further, authentication of the user whether the user is registered previously or not is performed by retrieving the database based on the user ID and the password replied from the user. In the event the user is not authenticated as a user previously registered, for example, the server device 70 gives a notice that the service is unavailable to the client device 50 and disconnects the line.

On the other hand, in the event the user is authenticated as a user previously registered, the server device 70 transmits an image as an example shown in FIG. 6 with respect to the client device 50 in order to provide, for example, a service of depositing money to other bank account (FIG. 10 (e)) And the service provider provides services based on selections made by the service user.

After receiving the services previously requested, if the service user transmits a request for disconnecting the telephone (FIG. 10 (f)) line with respect to the Internet connecting terminal 60 by operating the client device 50, the Internet connecting terminal 60 disconnects the telephone line (FIG. 10 (g)).

However, a service user had to transmit a user ID and a password to the server device as shown in FIG. 11 in order to receive the services provided by a service provider, in the conventional electronic business transaction system. Therefore, users, for example, troubled in operating PC have requested to improve the usability of the above-mentioned system which requires inputting items more than items input in the event of usual depositing by ATM of a bank and the like.

That is, in concrete, a system for providing services such as transfer to the other deposit account available only by input of a password corresponding to the personal identification number required in operating an ATM of a bank has been asked for, according to the above-mentioned example.

Further, a system which excels in human interface and resolves the problem caused in the event of inputting different user IDs for different service providers without making a mistake has been desired.

On the other hand, in the event of authenticating the user based only on the password without user ID, it is hard to identify the user and to maintain the liability of the security in transactions on the network, compared with the event of double authentication based on the user ID and the password. Accordingly, it is not preferable to authenticate the user only by input password without user IDs.

### SUMMARY OF THE INVENTION:

It is therefore an object of the present invention to provide an electronic business transaction system capable of maintaining security in business transactions on a network and improving usability for service users at the same time.

Other object of the present invention is to provide an electronic business transaction system which excels in human interface.

To solve the above-mentioned problems, the present invention provides an electronic business transaction system comprising;

a server device for providing services with respect to a client via a communications line,

a client device for receiving the services provided by the above-mentioned server device, and

a connecting terminal for connecting the above-mentioned server device with the above-mentioned client device via the above-mentioned communications line,

in which the above-mentioned server device comprises;

a database for storing identification information for identifying the above-mentioned client in correspondence with an individual password assigned to the client and telephone number information of the above-mentioned client,

obtaining means for obtaining the telephone number information of the above-mentioned client transmitted via the above-mentioned communications line, and

retrieving means for retrieving the above-mentioned identification information from the above-mentioned database based on the above-mentioned telephone number information obtained by the above-mentioned obtaining means. In the above-mentioned electronic business transaction system, when the above-mentioned telephone number information is authenticated as the information of the above-mentioned client according to the above-mentioned identification information retrieved by the above-mentioned retrieving means, the above-mentioned connecting terminal transmits an image for inputting and returning the password respect to the above-mentioned client. And in the event the above-mentioned password returned from the client matches the above-mentionied password stored in the above-mentioned database, the above-mentioned services are provided from the above-mentioned server device with respect to the above-mentioned client.

And the present invention provides the electronic business transaction system comprising;

a server device for providing services with respect to a client via a communications line,

a client device for receiving the services provided by the above-mentioned server device, and

a connecting terminal for connecting the above-mentioned server device with the above-mentioned client device via the above-mentioned communications line,

in which the above-mentioned connecting terminal comprises;

a first database for storing the telephone number information of the above-mentioned client in correspondence with the identification information for identifying the above-mentioned client,

first obtaining means for obtaining the telephone number information of the above-mentioned client transmitted via the above-mentioned communications line,

first retrieving means for retrieving the above-mentioned identification information from the above-mentioned first database based on the above-mentioned telephone number information obtained by the first obtaining means, and

transmitting means for transmitting the above-mentioned identification information retrieved by the first retrieving means to the above-mentioned server device. In the above-mentioned electronic business transaction system, the above-mentioned server device comprises;

a second database for storing the identification information for identifying the above-mentioned client in correspondence with an individual password assigned to the above-mentioned client,

second obtaining means for obtaining the above-mentioned identification information transmitted by the above-mentioned transmitting means and the above-mentioned password of the above-mentioned client transmitted via the above-mentioned communications line, and

retrieving means for retrieving the above-mentioned identification information from the above-mentioned second database based on the above-mentioned telephone number information and the above-mentioned password obtained by the above-mentioned obtaining means. And in the event the above-mentioned password is authenticated as the password of the above-mentioned client according to the above-mentioned identification information retrieved by the above-mentioned retrieving means, the above-mentioned services are provided with respect to the above-mentioned client from the server device.

Further, the server device of the present invention comprises;

a database for storing identification information for identifying the client in correspondence with an individual password assigned to the above-mentioned client and telephone number information of the above-mentioned client,

obtaining means for obtaining the telephone number information of the above-mentioned client transmitted via the above-mentioned communications line, and

retrieving means for retrieving the above-mentioned identification information from the above-mentioned database based on the above-mentioned telephone number information obtained by the above-mentioned obtaining means. And when the above-mentioned telephone number information is authenticated as the information of the above-mentioned client according to the above-mentioned identification information retrieved by the above-mentioned retrieving means, an image for inputting and returning the password is transmitted with respect to the above-mentioned client. And in the event the above-mentioned password returned from the client matches the above-mentioned password stored in the above-mentioned database, the above-mentioned services are provided from the above-mentioned server device with respect to the above-mentioned client.

Furthermore, the server device of the present invention comprises:

a database for storing identification information for identifying the client in correspondence with an individual password assigned to the above-mentioned client,

obtaining means for obtaining identification information for identifying the above-mentioned client transmitted from the connecting terminal connecting the main body of the server device with the client device operated by the above-mentioned client via the communications line and the above-mentioned password transmitted from the above-mentioned client via the above-mentioned communications line, and

retrieving means for retrieving the above-mentioned identification information from the above-mentioned database based on the obtained telephone number information and the above-mentioned password, in which services are provided with respect to the above-mentioned client, in the event a sender of the above-mentioned password is authenticated as the above-mentioned client according to the above-mentioned identification information retrieved by the above-mentioned retrieving means.

And further, the present invention is characterized in providing the client device used in the above-mentioned electronic business transaction system, in which business transactions may be performed between the above-mentioned server device and the above-mentioned connecting terminal via the above-mentioned communications line.

And the present invention is characterized in providing the connecting terminal used in the above-mentioned electronic business transaction system, in which business transactions may be performed between the above-mentioned server device and the above-mentioned client via the above-mentioned communications line.

Furthermore the present invention includes a connecting terminal for connecting a server device for providing services with respect to the client via the communications line and a client device for receiving the service provided by the above-mentioned server device via the above-mentioned communications line, in which

a database for storing the telephone number information of the above-mentioned client in correspondence with the identification information for identifying the above-mentioned client,

obtaining means for obtaining the telephone number information of the above-mentioned client transmitted via the communications line,

retrieving means for retrieving the above-mentioned identification information from the above-mentioned database based on the above-mentioned telephone number information obtained by the above-mentioned obtaining means, and

transmitting means for transmitting the above-mentioned identification information retrieved by the above-mentioned retrieving means to the above-mentioned server device. And in the event the sender of the above-mentioned password is authenticated as the above-mentioned client based on the above; mentioned identification information transmitted from the above-mentioned transmitting means and the individual password assigned to the above-mentioned client transmitted from the above-mentioned client device to the above-mentioned server device on the side of the above-mentioned server device, services are provided with respect to the above-mentioned client from the above-mentioned server device.

### BRIEF DESCRIPTION OF THE DRAWINGS:

FIG. 1 is a block diagram of an electronic business transaction system of an embodiment 1 of the present invention;

FIG. 2 illustrates inner block diagrams of a server device, the Internet connecting terminal and a client device shown in FIG. 1;

FIG. 3 is a sequence diagram for illustrating an operation of the electronic business transaction system shown in FIG. 1;

FIG. 4 is a diagram for showing an image transmitted at FIG. 3 (b);

FIG. 5 is a diagram for showing an image transmitted at FIG. 3 (f);

FIG. 6 is a diagram for showing an image transmitted at FIG. 3 (h);

FIG. 7 is an inner block diagram for illustrating the Internet connecting terminal in an embodiment 2 of the present invention;

FIG. 8 is a sequence diagram for illustrating an operation of the electronic business transaction system provided with the Internet connecting terminal shown in FIG. 7 therein;

FIG. 9 is a block diagram of a conventional electronic business transaction system;

FIG. 10 is a sequence diagram for illustrating an operation of the electronic business transaction system shown in FIG. 9; and

FIG. 11 is a diagram for showing an image for inputting a user ID and a password.

### DETAILED DESCRIPTION OF THE PREFERRED EMBODIMENT:

Referring now to the drawings, preferred embodiments of the present invention are described more particularly.

(Embodiment 1)

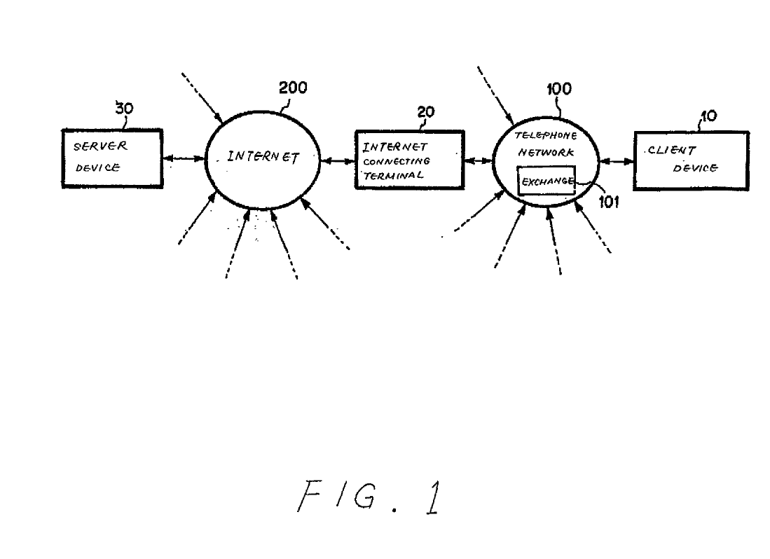

FIG. 1 is a block diagram of an electronic business transaction system of an embodiment 1 of the present invention. In FIG. 1, a server device 30 for providing services owned by banks, security companies, insurance companies, department stores and the like, a PC for receiving the services provided by the server device 30, a client device 10 such as a mobile terminal and the like, the Internet 200 for connecting the above-mentioned devices to each other, an Internet connecting terminal 20 and a telephone network 100 are shown.

Incidentally, the telephone network is equipped with an exchange 101 having transferring means for transferring a telephone number assigned to the client device 10 to the server device 20.

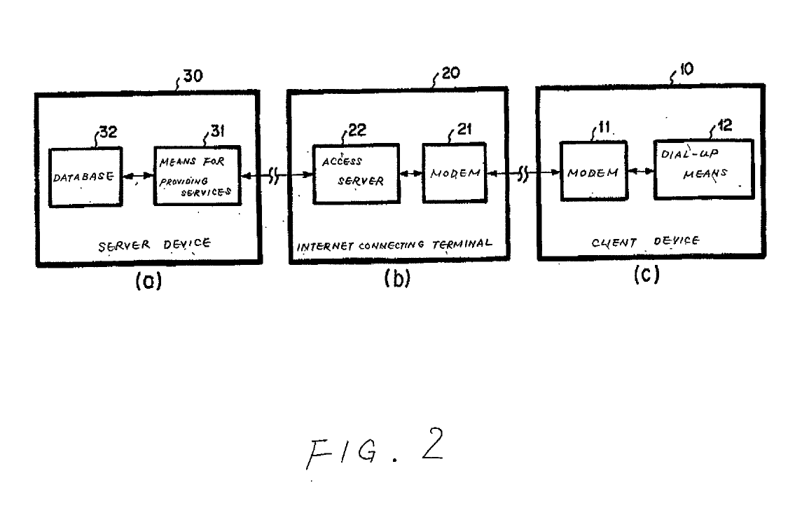

FIG. 2 (a) through FIG. 2 (c) are inner block diagrams of the server device 30, the Internet connecting terminal 20 and the client device 10 shown in FIG. 1 respectively. The client device 10 and the Internet connecting terminal 20 are equipped with modems 11 and 21 for performing modulation and demodulation of data transmitted and received there-between.

Incidentally, telephone number information on the side of the client device can be included in the data transmitted from the client device or obtained by the exchange 101 to transmit to the side of the server device 30.

The client device 10 comprises dial-up means for providing a dial-up connection to the Internet connecting terminal 20 via the telephone network 100, and the Internet connecting terminal 20 provides an access server 22 for transferring the telephone number information on the side of the client device to the server device by accessing the server device connected to the client device 10.

The server device 30 provides a database 32 for storing a user ID and a password assigned to the client individually in correspondence with the telephone number information on the side of the client device 10, and means for providing services for providing services to the service user when the service user is authenticated based on the password and the telephone number information transmitted from the side of the client device 10.

Here, the telephone network 100 shown in FIG. 1 is connected to a plurality of client devices and the Internet connecting terminals, and the Internet 200 is also connected to a plurality of server devices actually.

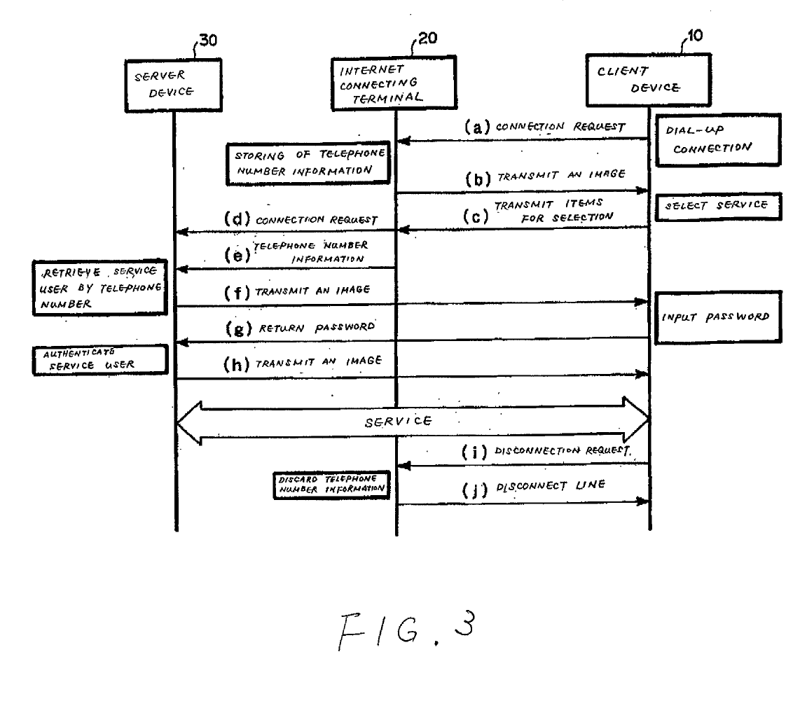

FIG. 3 is a sequence diagram for illustrating an operation of the electronic business transaction system shown in FIG. 1. Referring to the FIG. 3, an operation of the electronic business transaction system shown in FIG. 1 is described taking an example of a service user receiving a service provided by, for example, “X X bank” by accessing the server device 30 owned by the “X X bank”.

First, when the service user as a client operates the client device 10 to access to the server device 30, a connection request is transmitted to the Internet connecting terminal 20 via the telephone network 100 by dial-up means 12 (FIG. 3 (a)). Then the telephone number information on the side of the client device 10 is modulated by the modem 11 and transmitted to the Internet connecting terminal 20 via the telephone network 100 and the exchange 101.

Concretely, the telephone number information transmitted from the client device 10 is relayed by the exchange 101 and transmitted to the Internet connecting terminal 20 to which the client device 10 is connected by transferring means of the exchange 101 concurrently.

When the Internet connecting terminal 20 receives the connection request, the client device 10 and the Internet connecting terminal 20 are connected to each other via the telephone network 100. And when the Internet connecting terminal 20 receives the telephone number information transmitted from the client device 10, the Internet connecting terminal 20 demodulates the telephone number information by the modem 21 and store the information in a memory not shown in the access server 22.

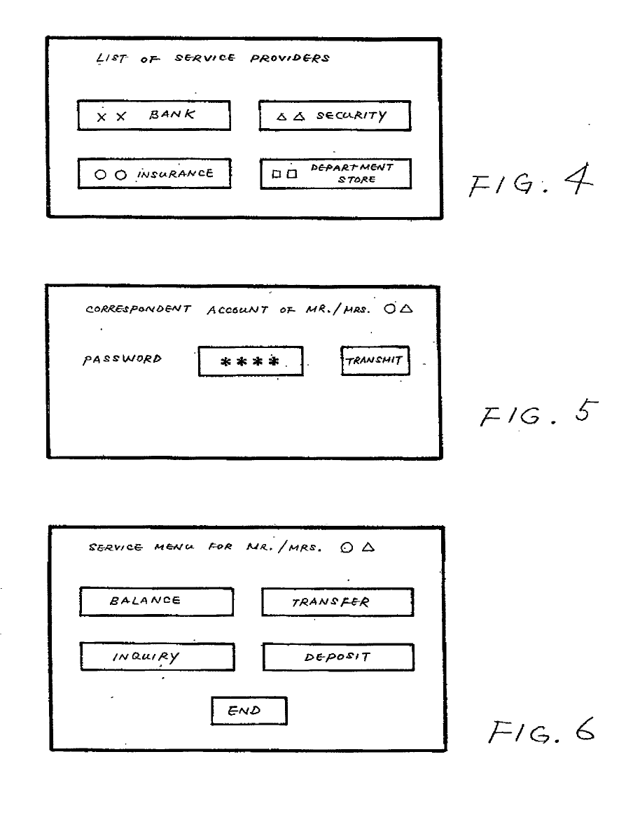

Next, the Internet connecting terminal 20 transmits an image of “a list of service providers” as shown in FIG. 4 for selecting a service provider from which the service user intends to receive the services (FIG. 3 (b)) to the client device 10. Here, as the service user is intending to receive the service provided by the “X X bank” by accessing with respect to the server device 30, “X X bank” is selected by clicking a mouse and the like accordingly. When the service user selects “X X bank”, the selection is transmitted as selection information to the Internet connecting terminal 20 by dial-up means 12 (FIG. 3 (c)).

It is also acceptable that the service user receives a notice that there is no contract concluded with the service provider selected by the service user, or an image for displaying only the service provider with whom the service user concluded a contract is selectively transmitted to the side of the client device 10 at FIG. 3 (b). In the above-mentioned event, the notice of required contract is given from the server device 30 to the Internet connecting terminal 20 in advance and the information of the service providers with whom the service user concluded contracts are stored in the database of the Internet connecting terminal 20. And only the service providers stored in the above-mentioned database are transmitted and displayed when the telephone number information is transmitted from the side of the client device 10 at FIG. 3 (a).

When the selection information is received by the Internet connecting terminal 20, the Internet connecting terminal 20 accesses with respect to the server device 30 via the Internet 200 by the access server 22 based on the selection information (FIG. 3 (d)). And when the Internet connecting terminal 20 and the server device 30 are connected to each other via the Internet 200, the telephone number information stored in the memory not shown in the access server 22 is transmitted to the server 30 (FIG. 3 (e)).

When the telephone number information is received by the server device 30, the server device 30 identifies the service user by demodulating the received telephone number information and retrieving the database 32 based on the telephone number information. Then, for example, an image of “bank account of Mr. or Mrs. ∘Δ” for inputting a personal identification number corresponding to the password as shown in FIG. 5 is transmitted to the service user by means for implementing services 31 (FIG. 3 (f)).

When the service user transmits the password to the server device 30 via the telephone network 100 and the Internet 200 by inputting the password based on the image shown in FIG. 5 (FIG. g)), the password is received by the server device 30. The server device 30 determines whether the received password is authenticated as the password of the identified service user or not.

In the event the password is not authenticated, means for implementing services 31 transmits a notice that the service is not available because of the wrong password with respect to the side of the client device and disconnects the line.

On the other hand, in the event the password is authenticated, an image of “service menu for Mr. or Mrs. ∘Δ” for selecting the items of, for example, “balance”, “transfer”, “input, output inquiry”, “deposit”, “end” and the like as shown in FIG. 6 is transmitted to the client device 10 by means for implementing services 31 (FIG. 3 (h)). And when the service user selects some of the above-mentioned items based on the image shown in FIG. 6, selected items are implemented by means for implementing services on the side of the server device 30. Then the service user can receive desirable services.

Thereafter, the image shown in FIG. 6 is displayed on the client device 10 again, after the services are implemented. If the service user requires some other services farther, the service user can select the items, and if not, the service user can select “end”.

When the item of “end” is selected, a request for disconnecting the telephone line is transmitted from the client device 10 with respect to the Internet connecting terminal 20 (FIG. 3 (i)). In response to the disconnection request, the telephone number information stored in the memory of the access server 22 is discarded and the telephone line is disconnected thereafter (FIG. 3 (j)). Thus, a provision of services to the service user is finished.

As mentioned above, a service user is identified in the server device 30. Therefore, the service user is provided with the services without transmitting the user ID to the side of the server device, in the present embodiment.

Here, an example of the event the disconnection request is transmitted from the client device 10 with respect to the Internet connecting terminal 20 is described, referring to FIG. 3 (i). However, the image shown in FIG. 4 can be displayed on the client device so that the service user can select “ΔΔ security” after making a request for receiving the services with respect to, for example, “X X bank”.

(Embodiment 2)

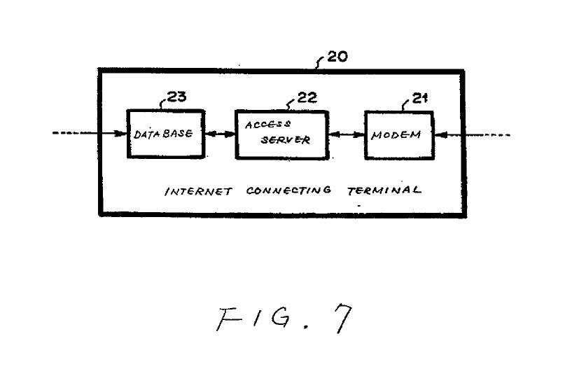

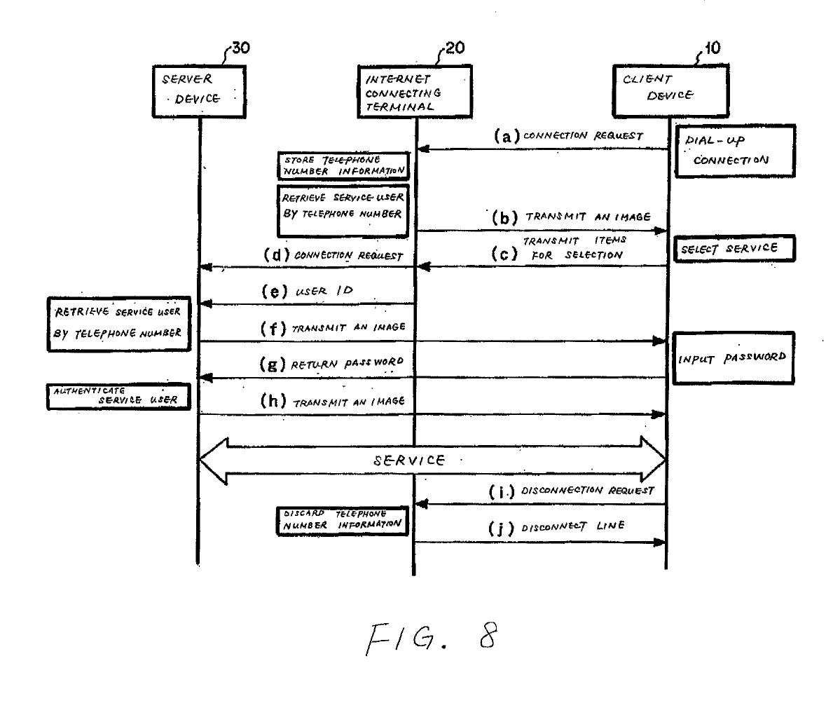

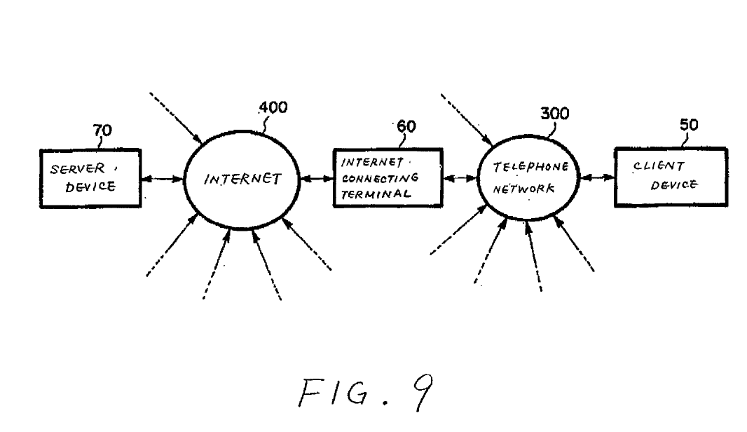

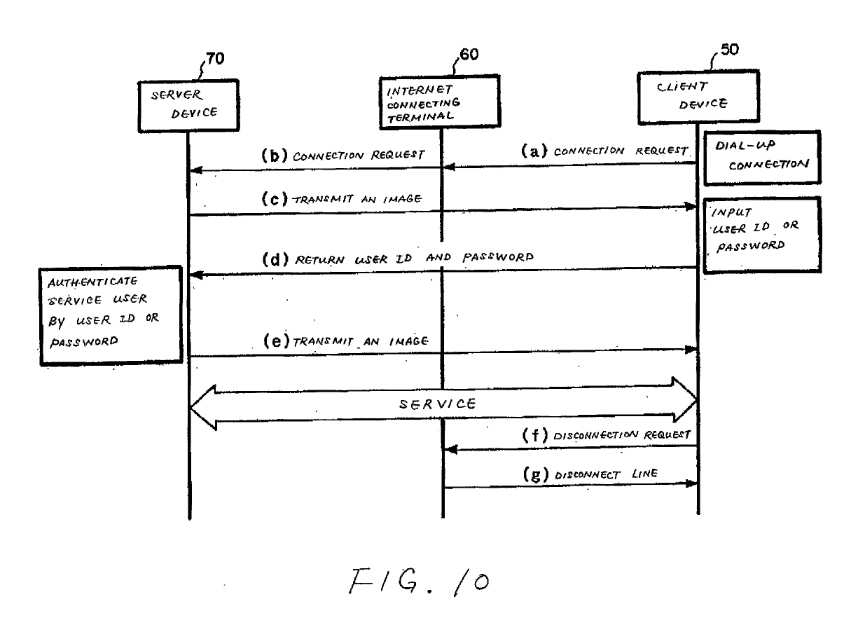

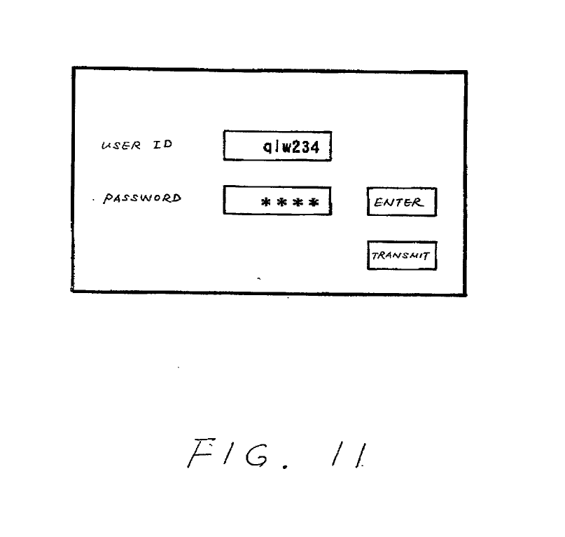

FIG. 7 is an inner block diagram of the Internet connecting terminal 20 in an embodiment 2 of the present invention. In the present embodiment, a database 23 for storing a user ID assigned to a client individually in correspondence with telephone number information on the side of the client device 10 is provided in the Internet connecting terminal 20. The service user is identified on the side of the Internet connecting terminal 20 and an image shown in FIG. 4 is transmitted to the side of the client device. Accordingly, the user ID in correspondence with the password is stored in the database 32 provided in the server device 30.

Incidentally, each number in FIG. 1 is corresponding to each number in FIG. 2 respectively. And the client device is composed similarly to the embodiment 1.

FIG. 8 is a sequence diagram for illustrating an operation of the electronic business transaction system provided with the Internet connecting terminal 20 shown in FIG. 2. Hereafter, an operation of the electronic business transaction system provided with the Internet connecting terminal 20 shown in FIG. 7 is described taking an example of the event that the service user receives services provided, for example, by “X X bank” by accessing with respect to the server device 30 owned by the “X X bank”.

First, the client device 10 and the Internet connecting terminal 20 are connected to each other via the telephone network 100 in response to a connection request given from the service user to the Internet connecting terminal 20 according to the similar sequence as FIG. 3 (FIG. 8 (a)). Here, the telephone number information on the side of the client device 10 is transmitted to the Internet connecting terminal 20 in the same manner as the embodiment 1.

The Internet connecting terminal 20 stores the received telephone number information in the access server 22 not shown and extract a user ID by retrieving the database 23 based on the telephone number information. And the Internet connecting terminal 20 transmits an image as shown in FIG. 4, for example, for selecting a service provider from whom the service user intending to receive services to the service user (FIG. 8 (b)).

Incidentally, in the event the user ED is not extracted by retrieving the database 23, for example, the Internet connecting terminal 20 transmits a notice that the service is not available because of the user ID missing to the side of the client device and disconnects the line. And when the service user selects the “X X bank” by clicking a mouse and the like on the side of the client device 10, the selection is transmitted as selection information to the Internet connecting terminal 20 by dial-up means (FIG. 8 (c)).

The Internet connecting terminal 20 further accesses with respect to the server device 30 via the Internet 200 by the access server 22 based on the selection information in response to the reception of the selection information. And after the Internet connecting terminal 20 and the server device 30 are connected to each other (FIG. 8 D)), an access from the Internet connecting terminal 20 to the server device 30 is established by the access server 22 for transmitting the user ID (FIG. 8 (e)). Thereafter, the server device 30 demodulates the user ID received from the Internet connecting terminal 20 and identifies the service user by retrieving the database 32 based on the user ID.

Next, the server device 30 transmits an image of, for example, FIG. 5 with respect to the client device 10 in the same manner as FIG. 3 (f) in order to receive the password from the service user in return (FIG. 8 (g)). And when the sender of the user ID is identified as the service user based on the password and the user ID transmitted from the service user and the Internet connecting terminal 20 respectively, an operation is performed in a similar sequence as FIG. 3 (h) through FIG. 3 (j) (FIG. 8 (h) through FIG. 8 (j))

Thus, the user ID is retrieved in the Internet connecting terminal 20 based on the telephone number information and transmitted to the server device 30, and the client is identified based on the password and the user ID transmitted from the client device 10 and the Internet connecting terminal 20 respectively in the server device 30. Accordingly, the service user can receive the services without transmitting the user ID to the side of the server device.

As clear form the description above, the service user can receive the services only by transmitting the password, according to each of the embodiments of the present invention. Therefore, usability for the service user can be enhanced. Incidentally, existing client databases can be used as databases 23 and 32 for authenticating the service user without newly establishing databases for identifying the service user.

As it has been described above, in the present invention, the telephone number information of a client is transmitted from the client with respect to a connecting terminal when a dial-up connection is provided. And when the sender of the information is identified as the client, an image for providing services with respect to the client is transmitted from a server device or the connecting terminal to the client. Therefore, the client can receive the services from the server device only by transmitting a password, which provides excellent usability of the electronic business transaction for the client.

What is claimed is:

1. An electronic business transaction system comprising;
a server device for providing services with respect to a client via a communications line,
a client device for receiving services provided by said server device, and
a connecting terminal for connecting said server device and said client device via said communications line, wherein said server device comprises;
a database for storing identification information for identifying said client in correspondence with an individual password assigned to said client and telephone number information of said client,
obtaining means for obtaining telephone number information of said client transmitted via said communications line, and
retrieving means for retrieving said identification information from said database based on said telephone number information obtained by obtaining means, characterized in that an image is transmitted from said connecting terminal with respect to said client in order to receive said password from said client in return, in the event said telephone number information is authenticated as the information of said client according to said identification information retrieved by said retrieving means and said services are provided with respect to said client from said sever device, in the event said password returned from said client matches said password stored in said database.

2. An electronic business transaction system comprising;
a server device for providing services with respect to a client via a communications line,
a client device for receiving services provided by said server device, and
a connecting terminal for connecting said server device and said client device via said communications line, wherein said connecting terminal comprises;
a first database for storing the telephone number information of said client in correspondence with the identification information for identifying said client,
a first obtaining means for obtaining the telephone number information of said client transmitted via said communications line,
first retrieving means for retrieving said identification information from said first database based on said obtained telephone number information, and
transmitting means for transmitting said identification information retrieved by said retrieving means to said server device,
and said server device comprises;
a second database for storing the identification information for identifying said client in correspondence with the individual password assigned to said client,
second obtaining means for obtaining said identification information transmitted by said transmitting means and said password of said client transmitted via said communications line, and
second retrieving means for retrieving said identification information from said second database based on said obtained telephone number information and said password,
characterized in that said services are provided with respect to said client from said server device in the event said password is authenticated as the one of said client according to said identification information retrieved by said retrieving means.

3. An electronic business transaction system as claimed in claim 1, wherein said communications line is the Internet or a telephone network.

4. An electronic business transaction system as claimed in claim 2, wherein said communications line is the Internet or a telephone network.

5. A server device comprising;
a database for storing identification information for identify a client in correspondence with an individual password assigned to said client and telephone number information of said client,
obtaining means for obtaining telephone number information of said client transmitted via a communications line, and
retrieving means for retrieving said identification information from said database based on said telephone number information obtained by said obtaining means, wherein an image is transmitted from said connecting terminal with respect to said client in order to receive said password from said client in return, in the event said telephone number information is authenticated as the information of said client according to said identification information retrieved by said retrieving means and said services are provided with respect to said client, in the event said password returned from said client matches said password stored in said database.

6. A server device comprising:
a database for storing identification information for identifying a client in correspondence with an individual password assigned to said client,
obtaining means for obtaining identification information for identifying said client transmitted from a connecting terminal connecting the main body of a server device with a client device operated by said client via the communications line and said password transmitted from said client via said communications line, and
retrieving means for retrieving said identification information from said database based on said obtained telephone number information and said password, wherein services are provided with respect to said client, in the event a sender of said password is authenticated as said client by said identification information retrieved by said retrieving means.

7. A client device used in the electronic business transaction system as claimed in claim 1, wherein business transactions are performed between said server device and said connecting terminal via said communications line.

8. A client device used in the electronic business transaction system as claimed in claim 2, wherein business transactions are performed between said server device and sad connecting terminal via sad communications line.

9. A client device used in the electronic business transaction system as claimed in claim 3, wherein business transactions are performed between said server device and said connecting terminal via said communications line.

10. A connecting terminal used in the electronic business transaction system as claimed in claim 1, wherein business transactions are performed between said server device and said connecting terminal via said communications line.

11. A connecting terminal used in the electronic business transaction system as claimed in claim 2, wherein business transactions are performed between said server device and said connecting terminal via said communications line.

12. A connecting terminal used in the electronic business transaction system as claimed in claim 3, wherein business transactions are performed between said server device and said connecting terminal via said communications line.

13. A connecting terminal for connecting a server device for providing services with respect to a client via a communications line with a client device for receiving the services provided by said server device via said communications line comprising;
a database for storing telephone number information of said client in correspondence with an identification information for identifying said client,
obtaining means for obtaining the telephone number information of said client transmitted via a communications line,
retrieving means for retrieving said identification information from said database based on said telephone number information, and
transmitting means for transmitting said retrieved identification information to said server device, wherein services are provided with respect to said client from said server device, in the event a sender of said password is authenticated as said client based on said identification information and an individual password assigned to said client transmitted form said client device to said server device on the side of said server device.
